(19) United States
(12) Patent Application Publication
(10) Pub. No.: US 2022/0248218 A1
(43) Pub. Date: Aug. 4, 2022

(54) PHYSICAL LAYER SECURED MESSAGE SEGMENTATION AND TRANSMISSION OVER DIFFERENT BEAMS

(71) Applicant: QUALCOMM Incorporated, San Diego, CA (US)

(72) Inventors: Noam ZACH, Kiryat Ono (IL); Guy WOLF, Rosh Haayin (IL); Sharon LEVY, Binyamina (IL); Ory EGER, Tel Aviv (IL); Ori BEN SHAHAR, Petach Tikva (IL); Lior UZIEL, Hod Hasharon (IL); Assaf TOUBOUL, Netanya (IL)

(21) Appl. No.: 17/168,080

(22) Filed: Feb. 4, 2021

(51) Int. Cl. H04W 12/03; H04B 7/0408

(52) U.S. Cl. CPC H04W 12/03; H04B 7/0408

(57) ABSTRACT

A method of secure wireless communication is performed by a user equipment (UE). The method receives, from a base station, sub-messages of a secured physical layer message, each sub-message received over a different beam. The method also decodes the sub-messages into decoded message segments. Further, the method reconstructs the secured physical layer message from the decoded message segments. A method of secure wireless communication by a base station includes receiving, from a user equipment (UE), a list of candidate beams for transmission and a reception metric for each of the candidate beams. The method also includes segmenting a secured physical layer message into sub-messages. The method further includes transmitting, to the UE, a control message indicating a structure of the secured message and a transmit beam for each of the plurality of sub-messages; and transmitting, to the UE, each sub-message over a different transmit beam of the candidate beams.

### FIELD OF THE DISCLOSURE

Aspects of the present disclosure generally relate to wireless communications, and more particularly to techniques and apparatuses for physical layer secured message segmentation and transmission over different 5G new radio (NR) beams.

### BACKGROUND

Wireless communications systems are widely deployed to provide various telecommunications services such as telephony, video, data, messaging, and broadcasts. Typical wireless communications systems may employ multiple-access technologies capable of supporting communications with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and long term evolution (LTE). LTE/LTE-Advanced is a set of enhancements to the universal mobile telecommunications system (UMTS) mobile standard promulgated by the Third Generation Partnership Project (3GPP).

A wireless communications network may include a number of base stations (BSs) that can support communications for a number of user equipment (UEs). A user equipment (UE) may communicate with a base station (BS) via the downlink and uplink. The downlink (or forward link) refers to the communications link from the BS to the UE, and the uplink (or reverse link) refers to the communications link from the UE to the BS. As will be described in more detail, a BS may be referred to as a Node B, a gNB, an access point (AP), a radio head, a transmit and receive point (TRP), a new radio (NR) BS, a 5G Node B, and/or the like.

The above multiple access technologies have been adopted in various telecommunications standards to provide a common protocol that enables different user equipment to communicate on a municipal, national, regional, and even global level. New radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation.

### SUMMARY

In one aspect of the present disclosure, a method of secure wireless communication by a user equipment (UE) includes receiving, from a base station, a number of sub-messages of a secured physical layer message, each sub-message received over a different beam. The method further includes decoding the sub-messages into decoded message segments. The method still further includes reconstructing the secured physical layer message from the decoded message segments.

Another aspect of the present disclosure is directed to an apparatus for secure wireless communication, by a user equipment (UE), having a memory and one or more processors coupled to the memory. The processor(s) is configured to receive, from a base station, a number of sub-messages of a secured physical layer message, each sub-message received over a different beam. The processor(s) is further configured to decode the sub-messages into a number of decoded message segments. The processor(s) is still further configured to reconstruct the secured physical layer message from the decoded message segments.

In one aspect of the present disclosure, a method of secure wireless communication by a base station includes receiving, from a user equipment (UE), a list of candidate beams for transmission and a reception metric for each of the candidate beams. The method further includes segmenting a secured physical layer message into a number of sub-messages. The method still further includes transmitting, to the UE, a control message indicating a structure of the secured message and a transmit beam for each of the sub-messages. The method also includes transmitting, to the UE, each sub-message over a different transmit beam of the candidate beams.

Another aspect of the present disclosure is directed to an apparatus for secure wireless communication, by a base station, having a memory and one or more processors coupled to the memory. The processor(s) is configured to receive, from a user equipment (UE), a list of candidate beams for transmission and a reception metric for each of the candidate beams. The processor(s) is further configured to segment a secured physical layer message into a number of sub-messages. The processor(s) is still further configured to transmit, to the UE, a control message indicating a structure of the secured message and a transmit beam for each of the sub-messages. The processor(s) is also configured to transmit, to the UE, each sub-message over a different transmit beam of the candidate beams.

Aspects generally include a method, apparatus, system, computer program product, non-transitory computer-readable medium, user equipment, base station, wireless communications device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that features of the present disclosure can be understood in detail, a particular description may be had by reference to aspects, some of which are illustrated in the appended drawings. It is to be noted, however, that the appended drawings illustrate only certain aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communications network, in accordance with various aspects of the present disclosure.

FIG. 2 is a block diagram conceptually illustrating an example of a base station in communication with a user equipment (UE) in a wireless communications network, in accordance with various aspects of the present disclosure.

FIG. 3 is a block diagram illustrating an environment for transmitting a message.

FIGS. 4A and 4B are block diagrams illustrating transmission beams directed to a target.

FIGS. 5A-5C are block diagrams illustrating a segmented message securely transmitted across multiple beams, in accordance with aspects of the present disclosure.

FIG. 6 is a timing diagram illustrating a segmented message securely transmitted across multiple beams, in accordance with aspects of the present disclosure.

FIG. 7 is a diagram illustrating an example process performed, for example, by a user equipment (UE), in accordance with various aspects of the present disclosure.

FIG. 8 is a diagram illustrating an example process performed, for example, by a base station, in accordance with various aspects of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method, which is practiced using other structure, functionality, or structure and functionality in addition to or other than the various aspects of the disclosure set forth. It should be understood that any aspect of the disclosure disclosed may be embodied by one or more elements of a claim.

Several aspects of telecommunications systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof Whether such elements are implemented as hardware or software depends upon the particular application and design constraints imposed on the overall system.

It should be noted that while aspects may be described using terminology commonly associated with 5G and later wireless technologies, aspects of the present disclosure can be applied in other generation-based communications systems, such as and including 3G and/or 4G technologies.

5G NR utilizes beamforming to increase spectral efficiency of a network. Beamforming involves multiple different transmit beams. A transmit beam may not be optimal in the sense that a transmitted message signal's energy may be directed in side lobes towards a few different spatial directions, rather than only towards the intended recipient. Eavesdroppers may intercept a signal by receiving signals from these side lobes.

In multipath environments, there are several possible configurations of transmit and receive beams that allow proper communication links. For example, a beam may reflect off a building and reach the intended receiver, similar to a line of sight signal. Thus, a first beam configuration may include the line of sight path and a second configuration may include the reflected path.

According to aspects of the present disclosure, multipath conditions allow for the use of several beams for the transmission of a message signal. Each of these beams may be transmitted in a different direction, resulting in each beam having side lobes in different directions. Thus, eavesdropping of a message signal that is split across different beams may be almost impossible. In aspects of the present disclosure, secured messages are segmented and transmitted over multiple beams to prevent eavesdropping. The information may be segmented in a way such that all sub-messages should be correctly decoded in order to successfully decode the segmented message. According to the present disclosure, each sub-message is transmitted over a different beam. Although side lobes can be received relatively well by an eavesdropper in one or more of the selected beams, the probability that all beams will have strong side lobes in the same direction of an unknown eavesdropper decreases as the number of used beams increases.

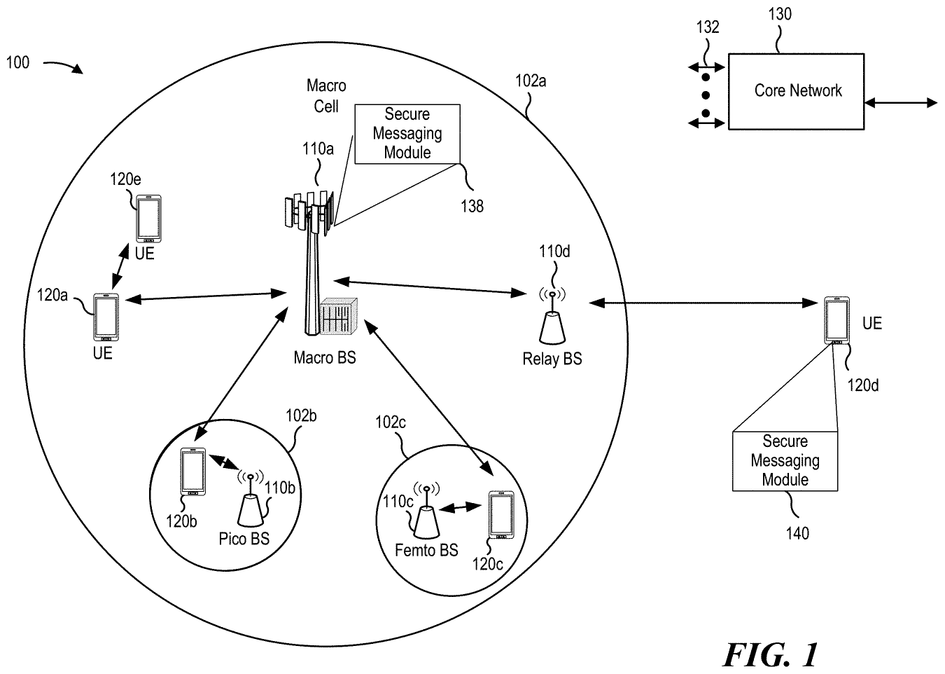

FIG. 1 is a diagram illustrating a network 100 in which aspects of the present disclosure may be practiced. The network 100 may be a 5G or NR network or some other wireless network, such as an LTE network. The wireless network 100 may include a number of BSs 110 (shown as BS 110a, BS 110b, BS 110c, and BS 110d) and other network entities. A BS is an entity that communicates with user equipment (UEs) and may also be referred to as a base station, an NR BS, a Node B, a gNB, a 5G node B (NB), an access point, a transmit and receive point (TRP), and/or the like. Each BS may provide communications coverage for a particular geographic area. In 3GPP, the term “cell” can refer to a coverage area of a BS and/or a BS subsystem serving this coverage area, depending on the context in which the term is used.

A BS may provide communications coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB,” “base station,” “NR BS,” “gNB,” “TRP,” “AP,” “node B,” “5G NB,” and “cell” may be used interchangeably.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

The wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communications between the BS 110a and UE 120d. A relay station may also be referred to as a relay BS, a relay base station, a relay, and/or the like.

The wireless network 100 may be a heterogeneous network that includes BSs of different types, e.g., macro BSs, pico BSs, femto BSs, relay BSs, and/or the like. These different types of BSs may have different transmit power levels, different coverage areas, and different impact on interference in the wireless network 100. For example, macro BSs may have a high transmit power level (e.g., 5 to 40 Watts) whereas pico BSs, femto BSs, and relay BSs may have lower transmit power levels (e.g., 0.1 to 2 Watts).

As an example, the BSs 110 (shown as BS 110a, BS 110b, BS 110c, and BS 110d) and the core network 130 may exchange communications via backhaul links 132 (e.g., S1, etc.). Base stations 110 may communicate with one another over other backhaul links (e.g., X2, etc.) either directly or indirectly (e.g., through core network 130).

The core network 130 may be an evolved packet core (EPC), which may include at least one mobility management entity (MME), at least one serving gateway (S-GW), and at least one packet data network (PDN) gateway (P-GW). The MME may be the control node that processes the signaling between the UEs 120 and the EPC. All user IP packets may be transferred through the S-GW, which itself may be connected to the P-GW. The P-GW may provide IP address allocation as well as other functions. The P-GW may be connected to the network operator's IP services. The operator's IP services may include the Internet, the Intranet, an IP multimedia subsystem (IMS), and a packet-switched (PS) streaming service.

The core network 130 may provide user authentication, access authorization, tracking, IP connectivity, and other access, routing, or mobility functions. One or more of the base stations 110 or access node controllers (ANCs) may interface with the core network 130 through backhaul links 132 (e.g., S1, S2, etc.) and may perform radio configuration and scheduling for communications with the UEs 120. In some configurations, various functions of each access network entity or base station 110 may be distributed across various network devices (e.g., radio heads and access network controllers) or consolidated into a single network device (e.g., a base station 110).

UEs 120 (e.g., 120a, 120b, 120c) may be dispersed throughout the wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communications device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

One or more UEs 120 may establish a protocol data unit (PDU) session for a network slice. In some cases, the UE 120 may select a network slice based on an application or subscription service. By having different network slices serving different applications or subscriptions, the UE 120 may improve its resource utilization in the wireless communications system 100, while also satisfying performance specifications of individual applications of the UE 120. In some cases, the network slices used by UE 120 may be served by an AMF (not shown in FIG. 1) associated with one or both of the base station 110 or core network 130. In addition, session management of the network slices may be performed by an access and mobility management function (AMF).

The UEs 120 may include a secure messaging module 140. For brevity, only one UE 120d is shown as including the secure messaging module 140. The secure messaging module 140 may receive, from a base station, a plurality of sub-messages of a secured physical layer message, each sub-message received over a different beam. The secure messaging module 140 may further decode the plurality of sub-messages into a plurality of decoded message segments. The secure messaging module 140 may still further reconstruct the secured physical layer message from the plurality of decoded message segments.

The base stations 110 may include a secure messaging module 138 for receiving, from a user equipment (UE), a list of candidate beams for transmission and a reception metric for each of the candidate beams. The secure messaging module 138 may also segment a secured physical layer message into a plurality of sub-messages. The secure messaging module 138 may further transmit, to the UE, a control message indicating a structure of the secured message and a transmit beam for each of the plurality of sub-messages. The secure messaging module 138 may still further transmit, to the UE, each sub-message over a different transmit beam of the candidate beams.

Some UEs may be considered machine-type communications (MTC) or evolved or enhanced machine-type communications (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communications link. Some UEs may be considered Internet-of-Things (IoT) devices, and/or may be implemented as NB-IoT (narrowband internet of things) devices. Some UEs may be considered a customer premises equipment (CPE). UE 120 may be included inside a housing that houses components of UE 120, such as processor components, memory components, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere as being performed by the base station 110. For example, the base station 110 may configure a UE 120 via downlink control information (DCI), radio resource control (RRC) signaling, a media access control-control element (MAC-CE) or via system information (e.g., a system information block (SIB).

As indicated above, FIG. 1 is provided merely as an example. Other examples may differ from what is described with regard to FIG. 1.

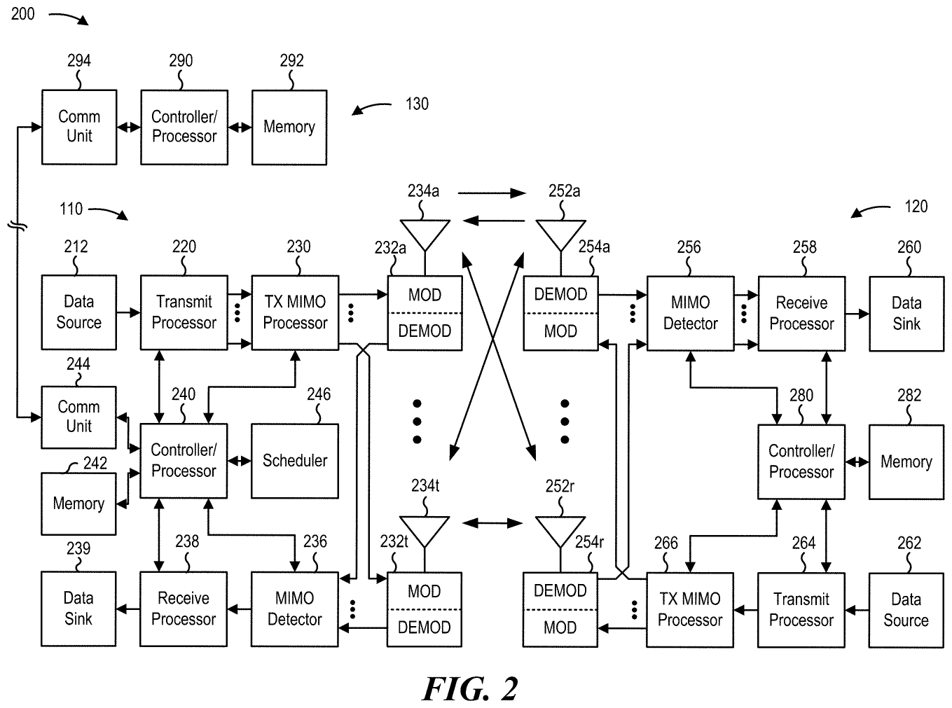

FIG. 2 shows a block diagram of a design 200 of the base station 110 and UE 120, which may be one of the base stations and one of the UEs in FIG. 1. The base station 110 may be equipped with T antennas 234a through 234t, and UE 120 may be equipped with R antennas 252a through 252r, where in general T≥1 and R≥1.

At the base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Decreasing the MCS lowers throughput but increases reliability of the transmission. The transmit processor 220 may also process system information (e.g., for semi-static resource partitioning information (SRPI) and/or the like) and control information (e.g., CQI requests, grants, upper layer signaling, and/or the like) and provide overhead symbols and control symbols. The transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At the UE 120, antennas 252a through 252r may receive the downlink signals from the base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for the UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of the UE 120 may be included in a housing.

On the uplink, at the UE 120, a transmit processor 264 may receive and process data from a data source 262 and control information (e.g., for reports comprising RSRP, RSSI, RSRQ, CQI, and/or the like) from the controller/processor 280. Transmit processor 264 may also generate reference symbols for one or more reference signals. The symbols from the transmit processor 264 may be precoded by a TX MIMO processor 266 if applicable, further processed by modulators 254a through 254r (e.g., for DFT-s-OFDM, CP-OFDM, and/or the like), and transmitted to the base station 110. At the base station 110, the uplink signals from the UE 120 and other UEs may be received by the antennas 234, processed by the demodulators 254, detected by a MIMO detector 236 if applicable, and further processed by a receive processor 238 to obtain decoded data and control information sent by the UE 120. The receive processor 238 may provide the decoded data to a data sink 239 and the decoded control information to a controller/processor 240. The base station 110 may include communications unit 244 and communicate to the core network 130 via the communications unit 244. The core network 130 may include a communications unit 294, a controller/processor 290, and a memory 292.

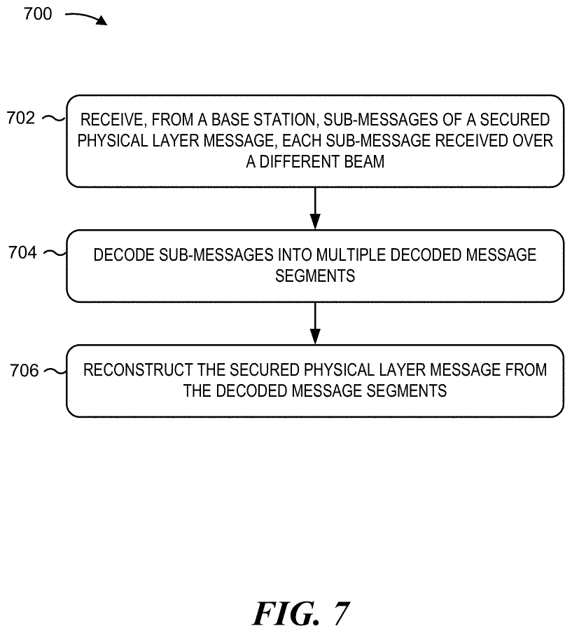

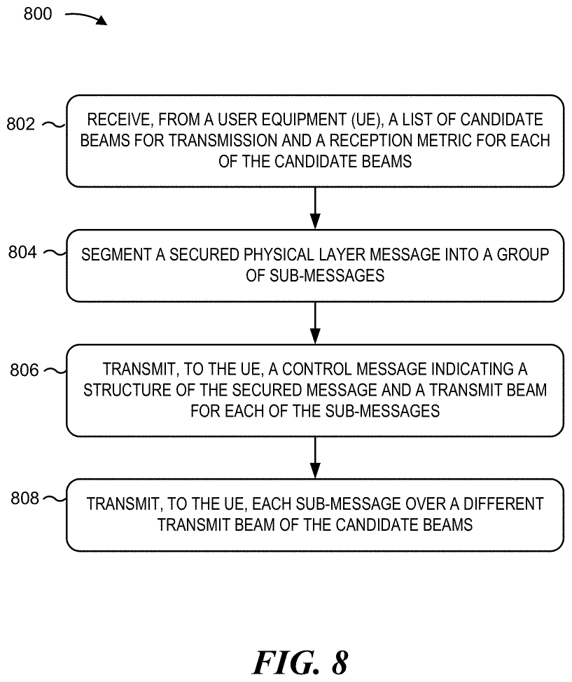

The controller/processor 240 of the base station 110, the controller/processor 280 of the UE 120, and/or any other component(s) of FIG. 2 may perform one or more techniques associated with secure message segmentation, as described in more detail elsewhere. For example, the controller/processor 240 of the base station 110, the controller/processor 280 of the UE 120, and/or any other component(s) of FIG. 2 may perform or direct operations of, for example, the processes of FIGS. 7 and 8 and/or other processes as described. Memories 242 and 282 may store data and program codes for the base station 110 and UE 120, respectively. A scheduler 246 may schedule UEs for data transmission on the downlink and/or uplink.

In some aspects, the UE 120 may include means for receiving, means for decoding, means for transmitting, and means for reconstructing. Additionally, the base station 110 may include means for receiving, means for segmenting, and means for transmitting. Such means may include one or more components of the UE 120 or base station 110 described in connection with FIG. 2.

As indicated above, FIG. 2 is provided merely as an example. Other examples may differ from what is described with regard to FIG. 2.

Physical layer security (PLS) is an emerging field in 5G NR communications that addresses difficulties of security key management in heterogeneous network (HetNet) environments, such as the network 100 depicted in FIG. 1. In addition, Internet of things (IoT) devices in a 5G NR network are designed to be small, inexpensive, and power efficient. The use of complex cryptographic methods for security purposes may create issues for these types of devices. The use of physical layer security is attractive for massive IoT networks.

5G NR utilizes beamforming to increase spectral efficiency of the network. Beamforming may include selecting different transmit beams to improve communication. A transmit beam may not be optimal in the sense that part of a transmitted message signal's energy may be directed in side lobes towards a few different spatial directions, rather than only towards an intended receive antenna. When using a large transmit array, there will be spatial directions to which only a minor part of the energy will be directed. These spatial directions are referred to as null regions.

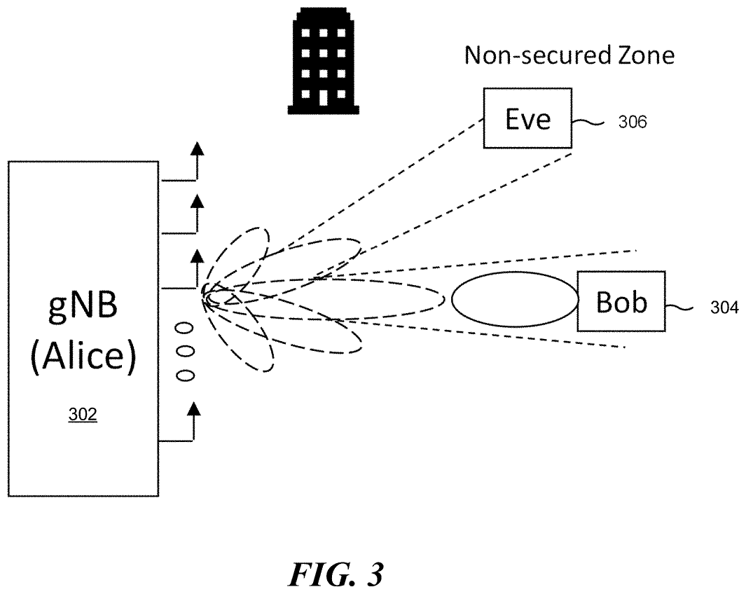

FIG. 3 is a block diagram illustrating an environment for transmitting a message. In FIG. 3, a 5G base station (e.g., gNB) 302 with an antenna array is shown as ‘Alice.’ The base station 302 may assume a desired transmission to a receiver 304 (e.g., a UE shown as ‘Bob’) is secure. However, an eavesdropper 306 (e.g., a UE shown as ‘Eve’) may be positioned where a beam side lobe provides some gain. The eavesdropper 306 may thus be able to listen to the communications sent to the receiver 304. Side lobes contain the same information as the beam in the target direction (e.g., the direction to the receiver 304), but with some power loss that can be recovered, for example, using a highly directional antenna.

In multipath environments, there are several possible configurations of transmit and receive beams that allow proper communication links. For example, a beam may reflect off a building and ultimately reach the receiver, similar to a line of sight signal. The different options for beam selection rely on the different channel clusters in the multipath channel.

According to aspects of the present disclosure, utilizing multipath conditions allows for the use of several beams for the transmission of the message signal. Each of these different beam directions has side lobes in different directions. Thus, the eavesdropping of a message signal that is split across different beams will be almost impossible.

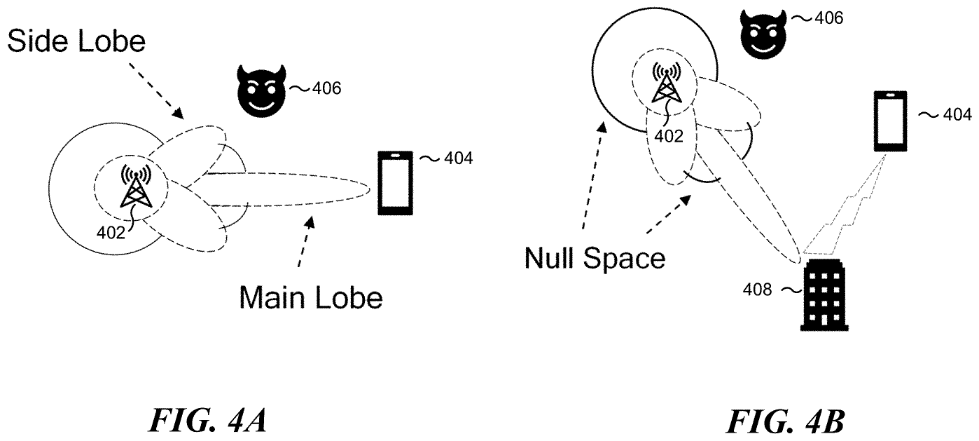

FIGS. 4A and 4B are block diagrams illustrating transmission beams directed to a target. FIG. 4A shows an example of a transmission using a line of sight beam (e.g., a main lobe directed towards the receiver) from a base station 402 to a receiver 404. In FIG. 4A, a side lobe is directed towards an eavesdropper 406. Thus, the eavesdropper 406 is able to receive the signal intended for the receiver 404. FIG. 4B shows transmission using a beam from a base station 402 that is reflected off a building 408. In FIG. 4B, the receiver 404 is still able to receive the signal, due to the reflection. The eavesdropper 406, however, is in the null space of the channel between the base station 402 and the receiver 404, and thus does not receive the signal.

In aspects of the present disclosure, secured messages are segmented and transmitted over multiple beams to prevent eavesdropping. The information may be segmented in a way such that all sub-messages should be correctly decoded in order to decode the message. According to the present disclosure, each sub-message will be transmitted over a different beam. The different beams that are suitable for good communication links between the receiver and the transmitter rely on the geographic position of both the transmitter and the receiver. Although one or more of the selected beam side lobes can be received relatively well by an eavesdropper, the probability that all beams will have strong side lobes in the same direction of an unknown eavesdropper decreases as the number of used beams increases.

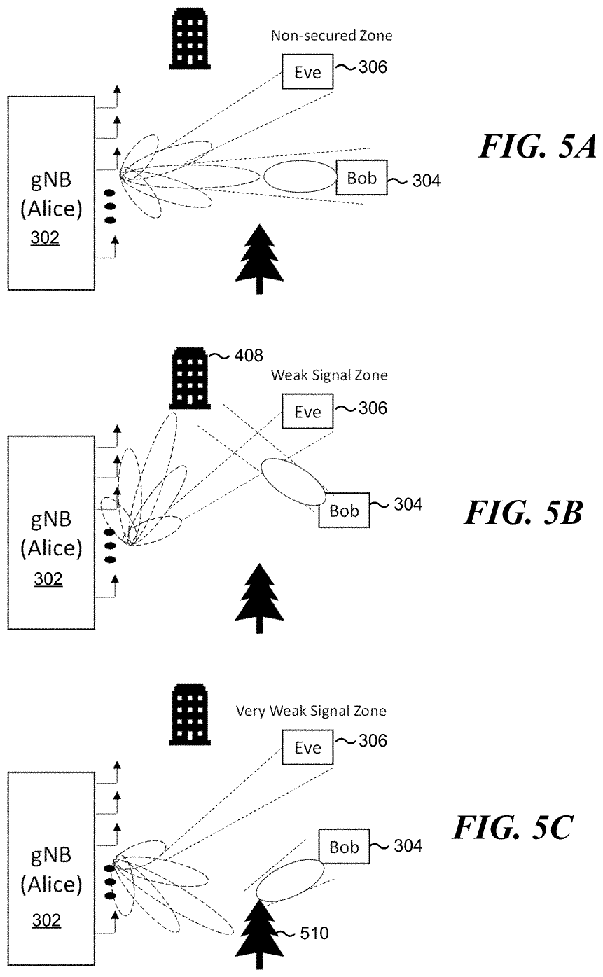

FIGS. 5A-5C are block diagrams illustrating a segmented message securely transmitted across multiple beams, in accordance with aspects of the present disclosure. FIG. 5A shows a base station (e.g., gNB) 302 transmitting a first physical layer block segment to a receiver 304 (e.g., ‘Bob’) over a main lobe via line of sight. The first physical layer block segment is part of a secured message divided by the base station into multiple segments (three segments in this example). In FIG. 5A, an eavesdropper 306 (e.g., ‘Eve’) is located in a non-secured zone and is able to receive the first physical layer block segment via a side lobe. FIG. 5B shows the base station 302 transmitting a second physical layer block segment of the secured message to the receiver 304. The beam for the first physical layer block segment differs from the beam for the second physical layer block segment. The base station 302 transmits the second physical layer block segment via a main lobe of the beam reflected off a building 408. In FIG. 5B, the eavesdropper 306 is located in a weak signal zone and may possibly be able to receive the second physical layer block segment via a side lobe.

FIG. 5C shows the base station 302 transmitting a third physical layer block segment of the secured message to the receiver 304. The base station 302 transmits the third physical layer block segment (e.g., the third message segment) via a main lobe of a beam reflected off a tree 510. The beam for the third message segment differs from the beams for the first and second message segments. In FIG. 5C, the eavesdropper 306 is located in a very weak signal zone and is unlikely to be able to receive the third physical layer block segment.

According to aspects of the present disclosure, after successfully receiving all three physical layer block segments, the receiver 304 decodes each segment and combines the decoded segments to reconstruct the secured message. The eavesdropper 306, however, is unable to receive and successfully decode all three segments. Thus, the eavesdropper 306 is unable to decode the secured message.

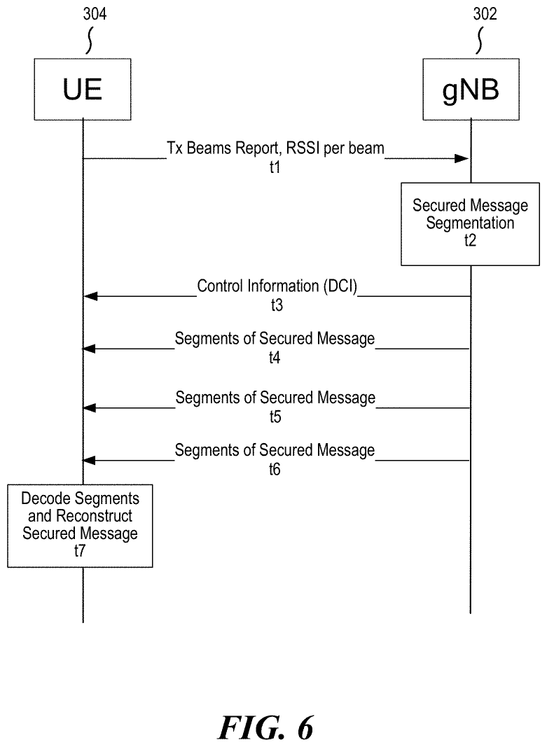

FIG. 6 is a timing diagram illustrating an example of securely transmitting a segmented message across multiple beams, in accordance with aspects of the present disclosure. In order to exploit the potential gain of beam diversity, a UE 304 reports to a base station (e.g., gNB) 302 a list of possible beams for transmission, along with respective signal quality or reception metrics (such as received signal strength indicator (RSSI)). According to aspects of the present disclosure, the UE 304 selects multiple beams that have a signal strength above a threshold, as candidate beams for transmission and reports them to the base station 302 at time t1.

At time t2, the base station 302 partitions a secured message into several segments. None of these physical layer segments can be self-decoded. That is, the information may be segmented in a way such that all sub-messages should be correctly decoded in order to decode the secured message. For example, interleaving or coding of the MAC layer information may occur before segmentation. Thus, successful decoding of a single physical layer segment decodes a non-consecutive part of the entire message, or decodes only a portion of the secure message that cannot be decoded without all of its parts. At time t3, the base station 302 indicates a structure of the segmented message and transmit beams for each segment. The base station 302 selects transmit beams from the candidate beams received from the UE 304 at time t1. The base station 302 may indicate the message structure as well as selected transmit beams, using a downlink control information (DCI) message, for example. The DCI message may indicate a total number of segments of the secured message. For each segment, the DCI message provides complete decoding information (such as exists in current DCI), beam information, and reconstructing information, such as segment indexes for the secured message, etc.

At times t4, t5, and t6, the base station 302 transmits each of the segments of the secured message to the UE 304. The base station 302 transmits each segment on a different transmit beam, such as shown in FIGS. 5A-5C. At time t7, the UE 304 decodes all segments and reconstructs the secured message.

Although not shown in FIG. 6, the base station 302 may signal to the UE 304 information for the beams report. For example, the information may include a maximum number of beams to be reported and an RSSI/RSRP (reference signal received power) threshold for candidate beams.

Although downlink communications are described as securely segmented, the present disclosure is equally applicable to uplink physical layer secure message segmentation.

According to the present disclosure, network security is improved with physical layer procedures. The present disclosure utilizes channel multipath for secured message transmission.

As indicated above, FIGS. 3-6 are provided as examples. Other examples may differ from what is described with respect to FIGS. 3-6.

FIG. 7 is a diagram illustrating an example process 700 performed, for example, by a user equipment (UE), in accordance with various aspects of the present disclosure. The example process 700 is an example of physical layer secured message segmentation and transmission over different beams. The operations of the process 700 may be implemented by a UE 120.

At block 702, the UE receives, from a base station, a number of sub-messages of a secured physical layer message, each sub-message received over a different beam. For example, the UE (e.g., using the antenna 252, demodulator (DEMOD) 254, multiple-input and multiple-output (MIMO) detector 256, receive processor 258, controller/processor 280, memory 282, and/or the like) may receive the sub-messages of the secured physical layer message over a different beam.

At block 704, the UE decodes the sub-messages into a number of decoded message segments. For example, the UE (e.g., using the controller/processor 280, memory 282, and/or the like) may decode the sub-messages into decoded message segments. At block 706, the UE reconstructs the secured physical layer message from the number of decoded message segments. For example, the UE (e.g., using the controller/processor 280, memory 282, and/or the like) may reconstruct the secured physical layer message from the decoded message segments.

FIG. 8 is a diagram illustrating an example process 800 performed, for example, by a base station, in accordance with various aspects of the present disclosure. The example process 800 is an example of physical layer secured message segmentation and transmission over different beams. The operations of the process 800 may be implemented by a base station 110, for example. At block 802, the base station receives, from a user equipment (UE), a list of candidate beams for transmission and a reception metric for each of the candidate beams. For example, the base station (e.g., using the antenna 234, demodulator (DEMOD) 232, multiple-input and multiple-output (MIMO) detector 236, receive processor 238, controller/processor 240, memory 242, and/or the like) may receive the list of candidate beams for transmission and the reception metric for each of the candidate beams.

At block 804, the base station segments a secured physical layer message into a number of sub-messages. For example, the base station (e.g., using the controller/processor 240, memory 242, scheduler 246, and/or the like) may segment the secured physical layer messages.

At block 806, the base station transmits, to the UE, a control message indicating a structure of the secured message and a transmit beam for each of the number of sub-messages. For example, the base station (e.g., using the antenna 234, MOD 232, TX MIMO processor 230, transmit processor 220, controller/processor 240, memory 242, and/or the like) may transmit the control message. At block 808, the base station transmits, to the UE, each sub-message over a different transmit beam of the candidate beams. For example, the base station (e.g., using the antenna 234, MOD 232, TX MIMO processor 230, transmit processor 220, controller/processor 240, memory 242, and/or the like) may transmit each sub-message.

Implementation examples are described in the following numbered clauses.
1. A method of secure wireless communication by a user equipment (UE), comprising:
   receiving, from a base station, a plurality of sub-messages of a secured physical layer message, each sub-message received over a different beam;
   decoding the plurality of sub-messages into a plurality of decoded message segments; and
   reconstructing the secured physical layer message from the plurality of decoded message segments.
2. The method of clause 1, further comprising receiving a control message indicating a structure of the secured message and a transmit beam for each of the plurality of sub-messages.
3. The method of clause 1 or 2, in which the structure comprises a total quantity of sub-messages of the secured message.
4. The method of any of the proceeding clauses, in which the control message further indicates decoding information and reconstruction information for each of the plurality of sub-messages.
5. The method of clause 1, further comprising transmitting, to the base station, a list of candidate beams for transmission and a reception metric for each of the candidate beams, the list of candidate beams including each of the different beams over which a sub-message of the plurality of sub-messages is received.
6. The method of any of the proceeding clauses, further comprising receiving an indication of maximum number of potential beams to report and a signal strength threshold for whether a received beam should be a candidate beam.
7. The method of any of clauses 1-6, further comprising:
   segmenting a secured physical layer uplink message into a plurality of uplink sub-messages;
   transmitting, to the base station, an uplink control message indicating an uplink structure of the secured uplink message and an uplink transmit beam for each of the plurality of uplink sub-messages; and
transmitting, to the base station, each uplink sub-message over a different uplink transmit beam.
8. A method of secure wireless communication by a base station, comprising:
   receiving, from a user equipment (UE), a list of candidate beams for transmission and a reception metric for each of the candidate beams;
   segmenting a secured physical layer message into a plurality of sub-messages;
   transmitting, to the UE, a control message indicating a structure of the secured message and a transmit beam for each of the plurality of sub-messages; and
   transmitting, to the UE, each sub-message over a different transmit beam of the candidate beams.
9. The method of clause 8, in which the structure comprises a total quantity of sub-messages of the secured message.
10. The method of clause 8 or 9, in which the control message further indicates decoding information and reconstruction information for each of the plurality of sub-messages.
11. The method of any of the clauses 8-10, further comprising transmitting, to the UE, a maximum number of potential beams to report.
12. The method of any of the clauses 8-11, further comprising transmitting, to the UE, a signal strength threshold for whether a received beam should be a candidate beam.
13. The method of any of clauses 8-12, further comprising:
   receiving, from the UE, a plurality of uplink sub-messages of a secured physical layer uplink message, each uplink sub-message received over a different uplink beam;
   decoding the plurality of uplink sub-messages into a plurality of decoded uplink message segments; and
   reconstructing the secured physical layer uplink message from the plurality of decoded uplink message segments.
14. An apparatus for secure wireless communication by a user equipment (UE), comprising:
   a memory; and
   at least one processor coupled to the memory, the at least one processor configured:
      to receive, from a base station, a plurality of sub-messages of a secured physical layer message, each sub-message received over a different beam;
      to decode the plurality of sub-messages into a plurality of decoded message segments; and
      to reconstruct the secured physical layer message from the plurality of decoded message segments.
15. The apparatus of clause 14, in which the at least one processor is further configured to receive a control message indicating a structure of the secured message and a transmit beam for each of the plurality of sub-messages.
16. The apparatus of clauses 14 or 15, in which the structure comprises a total quantity of sub-messages of the secured message.
17. The apparatus of clauses 14 or 15 or 16, in which the control message further indicates decoding information and reconstruction information for each of the plurality of sub-messages.
18. The apparatus of any of clauses 14-17, in which the at least one processor is further configured to transmit, to the base station, a list of candidate beams for transmission and a reception metric for each of the candidate beams, the list of candidate beams including each of the different beams over which a sub-message of the plurality of sub-messages is received.
19. The apparatus of any of the clauses 14-18, in which the at least one processor is further configured to receive an indication of maximum number of potential beams to report and a signal strength threshold for whether a received beam should be a candidate beam.
20. The apparatus of any of clauses 14-19, in which the at least one processor is further configured:
   to segment a secured physical layer uplink message into a plurality of uplink sub-messages;
   to transmit, to the base station, an uplink control message indicating an uplink structure of the secured uplink message and an uplink transmit beam for each of the plurality of uplink sub-messages; and
   to transmit, to the base station, each uplink sub-message over a different uplink transmit beam.
21. An apparatus for secure wireless communication by a base station comprising:
   a memory; and
   at least one processor coupled to the memory, the at least one processor configured:
      to receive, from a user equipment (UE), a list of candidate beams for transmission and a reception metric for each of the candidate beams;
      to segment a secured physical layer message into a plurality of sub-messages;
      to transmit, to the UE, a control message indicating a structure of the secured message and a transmit beam for each of the plurality of sub-messages; and
      to transmit, to the UE, each sub-message over a different transmit beam of the candidate beams.
22. The apparatus of clause 21, in which the structure comprises a total quantity of sub-messages of the secured message.
23. The apparatus of clause 21 or 22, in which the control message further indicates decoding information and reconstruction information for each of the plurality of sub-messages.
24. The apparatus of any of the clauses 21-23, in which the at least one processor is further configured to transmit, to the UE, a maximum number of potential beams to report.
25. The apparatus of any of the clauses 21-24, in which the at least one processor is further configured to transmit, to the UE, a signal strength threshold for whether a received beam should be a candidate beam.
26. The apparatus of any of the clauses 21-25, in which the at least one processor is further configured:
   to receive, from the UE, a plurality of uplink sub-messages of a secured physical layer uplink message, each uplink sub-message received over a different uplink beam;
   to decode the plurality of uplink sub-messages into a plurality of decoded uplink message segments; and
   to reconstruct the secured physical layer uplink message from the plurality of decoded uplink message segments.

The foregoing disclosure provides illustration and description, but is not intended to be exhaustive or to limit the aspects to the precise form disclosed. Modifications and variations may be made in light of the above disclosure or may be acquired from practice of the aspects.

As used, the term “component” is intended to be broadly construed as hardware, firmware, and/or a combination of hardware and software. As used, a processor is implemented in hardware, firmware, and/or a combination of hardware and software.

Some aspects are described in connection with thresholds. As used, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described may be implemented in different forms of hardware, firmware, and/or a combination of hardware and software. The actual specialized control hardware or software code used to implement these systems and/or methods is not limiting of the aspects. Thus, the operation and behavior of the systems and/or methods were described without reference to specific software code—it being understood that software and hardware can be designed to implement the systems and/or methods based, at least in part, on the description.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used should be construed as critical or essential unless explicitly described as such. Also, as used, the articles “a” and “an” are intended to include one or more items, and may be used interchangeably with “one or more.” Furthermore, as used, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used, the terms “has,” “have,” “having,” and/or the like are intended to be open-ended terms. Further, the phrase “based on” is intended to mean “based, at least in part, on” unless explicitly stated otherwise.

What is claimed is:

1. A method of secure wireless communication by a user equipment (UE), comprising:
receiving, from a base station, a plurality of sub-messages of a secured physical layer message, each sub-message received over a different beam;
decoding the plurality of sub-messages into a plurality of decoded message segments; and
reconstructing the secured physical layer message from the plurality of decoded message segments.

2. The method of claim 1, further comprising receiving a control message indicating a structure of the secured message and a transmit beam for each of the plurality of sub-messages.

3. The method of claim 2, in which the structure comprises a total quantity of sub-messages of the secured message.

4. The method of claim 2, in which the control message further indicates decoding information and reconstruction information for each of the plurality of sub-messages.

5. The method of claim 1, further comprising transmitting, to the base station, a list of candidate beams for transmission and a reception metric for each of the candidate beams, the list of candidate beams including each of the different beams over which a sub-message of the plurality of sub-messages is received.

6. The method of claim 5, further comprising receiving an indication of maximum number of potential beams to report and a signal strength threshold for whether a received beam should be a candidate beam.

7. The method of claim 1, further comprising:
segmenting a secured physical layer uplink message into a plurality of uplink sub-messages;
transmitting, to the base station, an uplink control message indicating an uplink structure of the secured uplink message and an uplink transmit beam for each of the plurality of uplink sub-messages; and
transmitting, to the base station, each uplink sub-message over a different uplink transmit beam.

8. A method of secure wireless communication by a base station, comprising:
receiving, from a user equipment (UE), a list of candidate beams for transmission and a reception metric for each of the candidate beams;
segmenting a secured physical layer message into a plurality of sub-messages;
transmitting, to the UE, a control message indicating a structure of the secured message and a transmit beam for each of the plurality of sub-messages; and
transmitting, to the UE, each sub-message over a different transmit beam of the candidate beams.

9. The method of claim 8, in which the structure comprises a total quantity of sub-messages of the secured message.

10. The method of claim 8, in which the control message further indicates decoding information and reconstruction information for each of the plurality of sub-messages.

11. The method of claim 8, further comprising transmitting, to the UE, a maximum number of potential beams to report.

12. The method of claim 8, further comprising transmitting, to the UE, a signal strength threshold for whether a received beam should be a candidate beam.

13. The method of claim 8, further comprising:
receiving, from the UE, a plurality of uplink sub-messages of a secured physical layer uplink message, each uplink sub-message received over a different uplink beam;
decoding the plurality of uplink sub-messages into a plurality of decoded uplink message segments; and
reconstructing the secured physical layer uplink message from the plurality of decoded uplink message segments.

14. An apparatus for secure wireless communication by a user equipment (UE), comprising:
a memory; and
at least one processor coupled to the memory, the at least one processor configured:
to receive, from a base station, a plurality of sub-messages of a secured physical layer message, each sub-message received over a different beam;
to decode the plurality of sub-messages into a plurality of decoded message segments; and
to reconstruct the secured physical layer message from the plurality of decoded message segments.

15. The apparatus of claim 14, in which the at least one processor is further configured to receive a control message indicating a structure of the secured message and a transmit beam for each of the plurality of sub-messages.

16. The apparatus of claim 15, in which the structure comprises a total quantity of sub-messages of the secured message.

17. The apparatus of claim 15, in which the control message further indicates decoding information and reconstruction information for each of the plurality of sub-messages.

18. The apparatus of claim 14, in which the at least one processor is further configured to transmit, to the base station, a list of candidate beams for transmission and a reception metric for each of the candidate beams, the list of candidate beams including each of the different beams over which a sub-message of the plurality of sub-messages is received.

19. The apparatus of claim 18, in which the at least one processor is further configured to receive an indication of maximum number of potential beams to report and a signal strength threshold for whether a received beam should be a candidate beam.

20. The apparatus of claim 14, in which the at least one processor is further configured:
to segment a secured physical layer uplink message into a plurality of uplink sub-messages;
to transmit, to the base station, an uplink control message indicating an uplink structure of the secured uplink message and an uplink transmit beam for each of the plurality of uplink sub-messages; and
to transmit, to the base station, each uplink sub-message over a different uplink transmit beam.

21. An apparatus for secure wireless communication by a base station comprising:
a memory; and
at least one processor coupled to the memory, the at least one processor configured:
to receive, from a user equipment (UE), a list of candidate beams for transmission and a reception metric for each of the candidate beams;
to segment a secured physical layer message into a plurality of sub-messages;
to transmit, to the UE, a control message indicating a structure of the secured message and a transmit beam for each of the plurality of sub-messages; and
to transmit, to the UE, each sub-message over a different transmit beam of the candidate beams.

22. The apparatus of claim 21, in which the structure comprises a total quantity of sub-messages of the secured message.

23. The apparatus of claim 21, in which the control message further indicates decoding information and reconstruction information for each of the plurality of sub-messages.

24. The apparatus of claim 21, in which the at least one processor is further configured to transmit, to the UE, a maximum number of potential beams to report.

25. The apparatus of claim 21, in which the at least one processor is further configured to transmit, to the UE, a signal strength threshold for whether a received beam should be a candidate beam.

26. The apparatus of claim 21, in which the at least one processor is further configured:
to receive, from the UE, a plurality of uplink sub-messages of a secured physical layer uplink message, each uplink sub-message received over a different uplink beam;
to decode the plurality of uplink sub-messages into a plurality of decoded uplink message segments; and
to reconstruct the secured physical layer uplink message from the plurality of decoded uplink message segments.
